(19) United States
(12) Patent Application Publication
(10) Pub. No.: US 2002/0093519 A1
(43) Pub. Date: Jul. 18, 2002

(54) Method for automatically connecting a text string to an installation element in a representation of an installation system

(75) Inventor: Bjorn Broberg, Torekov (SE)

Correspondence Address: WEINGARTEN, SCHURGIN, GAGNEBIN & LEBOVICI LLP, TEN POST OFFICE SQUARE, BOSTON, MA, 02109, US

(73) Assignee: LINDAB AB

(21) Appl. No.: 09/760,408

(22) Filed: Jan. 12, 2001

(51) Int. Cl. G09G 5/00

(52) U.S. Cl. 345/689; 703/1

(57) ABSTRACT

A method for automatically generating and connecting a text string to an installation element in a representation of an installation system in a computer readable form, such as a CAD-drawing. The text string indicates the properties of said element in said installation system. The method comprises the steps of identifying the type of said installation element; reading for each element, from a database, predetermined rules and a text pattern corresponding to the type of said element. Further, the method comprises the steps of combining, from said representation of an installation system, the properties of said element, such as dimensions, with said text pattern to produce a text string for said element; and connecting said text string with said element in said representation.

### FIELD OF THE INVENTION

The present invention relates to a method for automatically generating and connecting a text string to at least one installation element in a representation of an installation system in a computer readable form, such as a CAD-drawing, said text string indicating the properties of said element in said installation system.

### BACKGROUND OF THE INVENTION

The invention relates to completion of representations of installation systems, such as electric systems, heating, cooling, ventilation, sanitary and sprinkler installations systems. Installation systems could be constructed of several different elements of different types, such as ducts, silencers, dampers or terminals. Mostly, installation systems are complex and often constitute a unique composition of components. The drawing of the system, i.e. the representation of the system, describes which elements are used, how they are interrelated, where they are to be installed, etc.

Installation systems are nowadays usually constructed by means of software for computer aided design (CAD). An example of such software is provided by the applicant with the product name CADvent®. With such software it is possible to create a representation of an installation system in a computer readable form. The installation system could be presented in either two or three dimensions (2-D and 3-D, respectively).

To facilitate for the user, for example a craftsman, of a representation of an installation system, there is often a need for written information in conjunction with the elements of the installation system, which information describes some of the elements properties. The properties could be material type, dimensions, flow rate, output, etc.

Even though the currently known software provides the user with means to write text onto the representation. This has to be done manually, and is tedious and cumbersome. When applying the text, the user often has to check with external resources in order to obtain the properties of said elements. Also, the user has to make a decision for each element, regarding which information is needed and how to arrange the information onto the representation, i.e. the drawing. Although the computerized drawing procedure provide means for writing text, this manual procedure is time consuming both with regards to obtaining information and making decisions of which and how to apply information. It is also a source of errors, since the tasks are performed manually. Additionally, when the specifications of an installation element product change, there is a risk that the drawing will be invalid. Another problem is that the written information on current representations of installation systems often are adapted to a particular group of people, making it difficult for other groups to interpret the drawing. A manager and a craftsman generally need different information. For instance, a manager would probably would have problems interpreting “T1-160”, but simpler description, such as “circular duct”, would not work as an instruction to a craftsman.

### OBJECT OF THE INVENTION

It is therefore an object of the present invention to provide a method for automatically generating and connecting a text string to an installation element in a representation of an installation system in a computer readable form, such as a CAD-drawing, overcoming the above mentioned problems.

Another object is to provide such a method, which additionally is adaptable to different user needs, overcoming the above mentioned problems.

This object is achieved by means of a method according to the enclosed claims.

### SUMMARY OF THE INVENTION

According to the invention, a method for automatically generating and connecting a text string to at least one installation element in a representation of an installation system in a computer readable form, such as a CAD-drawing, said text string indicating the properties of said element in said installation system, comprises, for each installation element, the steps of:

identifying the type of said installation element used in said representation of an installation system;

reading for said element type, from a database, predetermined rules and a text pattern corresponding to the type of said element, said rules determining which properties of said element type to present and said text pattern being a layout scheme for said determined properties;

combining, from said representation of an installation system, the properties of said element, such as dimensions, with said text pattern to produce a text string for said element based on said rules; and

connecting said text string with said element in said representation.

Hereby, a method is provided for an efficient and a less erroneous way of connecting text strings to elements in a representation of an installation system. This makes it possible for each element to automatically obtain a text string, which describes its properties. The method also provides the possibility to let different element types have different corresponding text patterns. This makes it possible to customize the layout, and which properties to connect, for a group of elements, each belonging to the same type of element.

Additionally, it would not involve much effort to execute such a method each time the properties of an installation element change. Since the text string is not generated until the method is executed, the method will always generate and connect the latest updated properties with the corresponding installation element.

Preferably, the method comprises the further step of assigning users different predetermined rules and text patterns, allowing generating and connecting a user specific text string for each element. Such a method would allow producing drawings with different text strings by simply defining different rules for different target groups. This will drastically improve the readability of the representation, which for example gives a better base for decisions and reduces the risk of misunderstanding.

Preferably, the method comprises the further steps of:

defining additional rules for said element type, said additional rules settle whether a text string for said element type is to be presented; and

determining, based on said additional rules of said element type, whether said text string is to be printed.

With such extended rules the automated process is improved with respect to the quality and efficiency of the method, since it becomes possible for the user to in advance determine which element types that will get a description.

A time consuming task in the currently known techniques for connecting a text string with information to an installation element in a representation of an installation system is to find a suitable location for the text string on the representation. This could be taken care of if said predetermined rules and said text pattern additionally comprises location constraints and instructions for positioning said text string, and the step of connecting said text string comprises the substeps of:

searching said representation of an installation system in order to find a location to put said text string satisfying the predetermined rules; and

applying said text string to the representation of the installation system on said location.

The invention further relates to a corresponding apparatus and computer readable medium.

### BRIEF DESCRIPTION OF THE DRAWINGS

For exemplifying purposes, the invention will be described by way of embodiments thereof, and with reference to the attached drawings, wherein:

FIG. 1a-1c illustrate examples of different text patterns;

FIG. 2 shows the relationship between elements, element types and text patterns;

FIG. 3 is a flow-chart illustrating a method according to the invention;

FIG. 4 is a flow-chart illustrating alternative embodiments of the invention;

FIG. 5 shows an example of a representation of an installation system before the text strings are applied; and

FIG. 6 shows an example of a representation of an installation system after the text strings are applied.

### DESCRIPTION OF PREFERRED EMBODIMENTS

A preferred embodiment of the invention will now be described. The invention will be described with specific reference to ventilation systems, but it should be appreciated by those versed in the art that the invention is equally useful for other types of installation systems, such as installation systems, such as electric systems, heating, cooling, sanitary and sprinkler installations systems. The method according to the invention automatically generates and connects a text string to at least one installation element in a representation of an installation system in a computer readable form, such as a CAD-drawing. The text string indicates the properties of an element, such as material and dimensions. The text string is generated by combining the properties of an installation element with a text pattern, i.e. a layout scheme, satisfying predetermined rules.

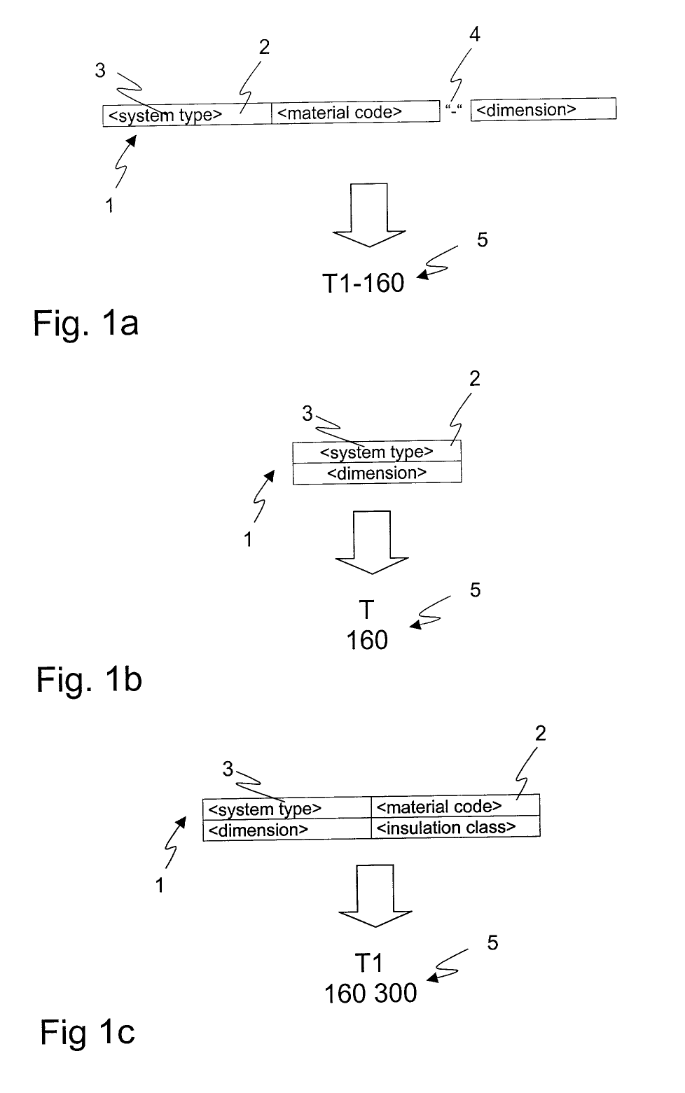

Referring to FIG. 1, the constitution of a text pattern 1 will now be described. A text pattern 1 consists of a number of fields 2; the text patterns 1 in FIG. 1a through 1c have four, two and four fields 2 respectively. They can be arranged in different orders, for example in a row as in FIG. 1a, in a column as in FIG. 1b or in a matrix as in FIG. 1c. This makes it possible to create an indefinite number of different layouts of the text pattern 1.

Each field 2 holds a variable 3, in the case of FIG. 1a, the fields 2 hold the variables “system type”, “material code” and “dimension”. A text pattern 1 can also contain fixed characters 4, such as hyphens. When combining the properties of an element with a text pattern, the variables get their values. The text string 5, which is the result of the method according to the invention, is shown in FIGS. 1a to 1c as the text string 5 below the block arrow.

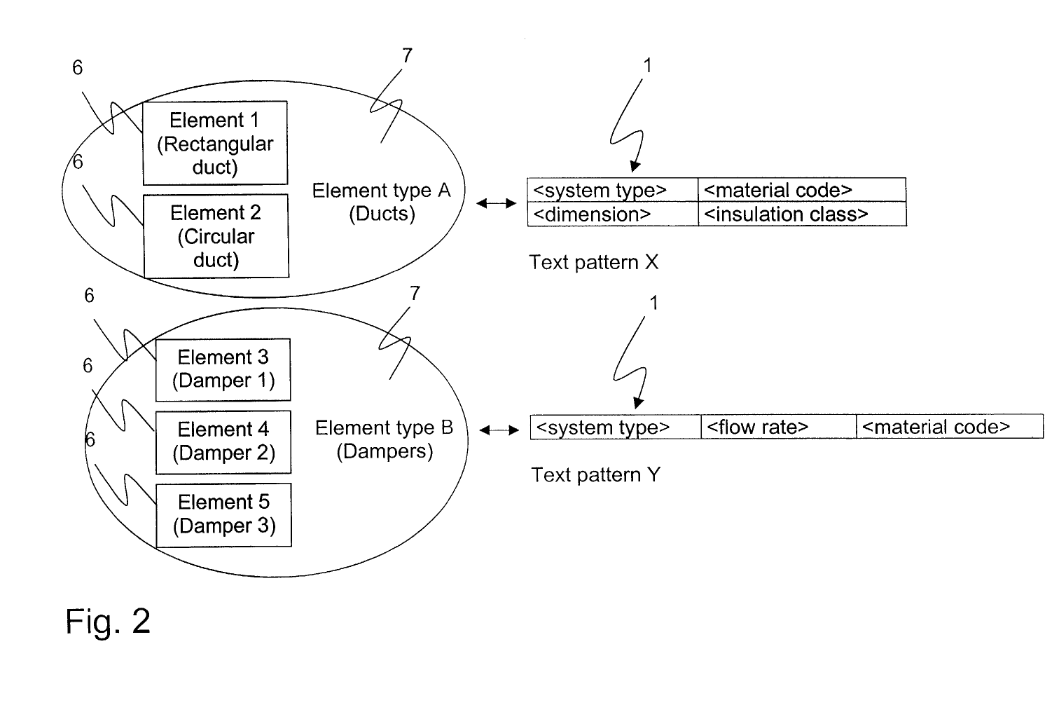

In FIG. 2 the relationship between elements 6, element types 7 and text patterns 1 are illustrated. Installation elements 6 in an installation system are for example ducts, silencers and dampers. A group of similar or identical elements 6 are of the same element type 7. For example a rectangular and a circular duct are both of the element type 7 “ducts”. Then each element type 7 corresponds to a text pattern 1. The invention is not limited to this example of relationship; the elements 6, element types 7 and text patterns 1 can of course include more levels of hierarchy.

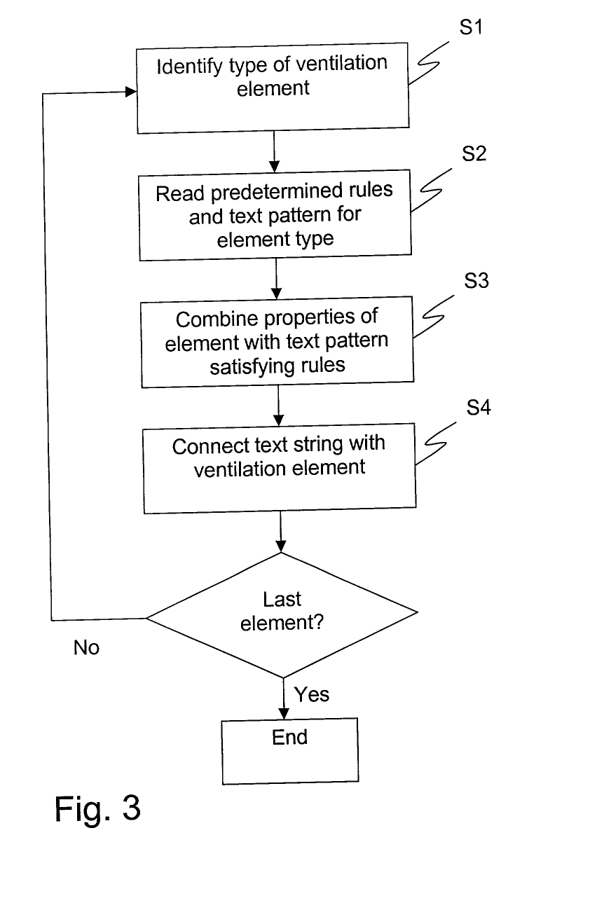

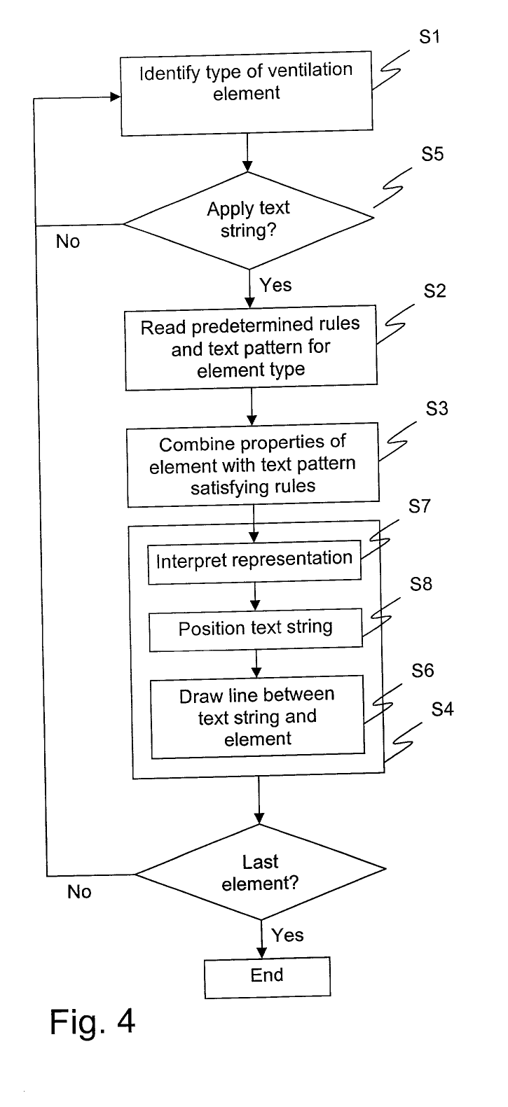

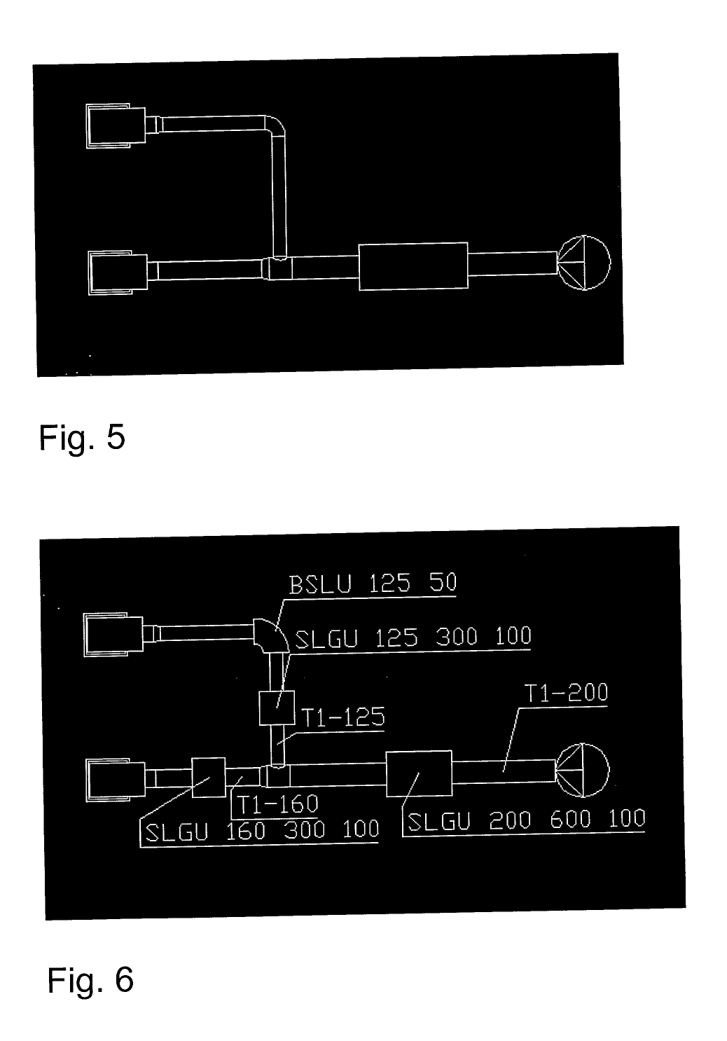

Referring to FIG. 3, a method for automatically generating and connecting a text string to an installation element in a representation of an installation system in a computer readable form according to a preferred embodiment of the invention is now to be described.

The method comprises a first step S1, wherein the types of the elements of an installation system, which is represented in a computer readable form, are identified. The representation of an installation system in a computer readable form is preferably a CAD-drawing, which could be created in AutoCAD®, a software provided by Autodesk Inc. Preferably this software is complemented with the previously mentioned software CADvent®, provided by the applicant. With such software it becomes possible to create elements, which represent actual products. The representation of the installation system would then be built up from elements, each preferably having a unique identification (ID) in the system. Each ID would then be connected to the element's properties. Examples of properties are: the element's origin coordinates, it's extension along the x-, y- and possibly z-axis, which product it represent, flow data of the element, material of the element, and especially the type of the element.

In the representation of the installation system, it is likely that there are several elements, which represent the same or similar products, but differ in for example diameter or the shape of the cross-section. These could be said to be of the same type, for example the elements “circular duct with a 300 mm diameter” and “rectangular duct with a height of 200 mm and a width of 500 mm” could be considered to belong to the type “ducts”. This is merely an example, the classification into types, sub-types or the like is up to the designer of the installation system.

In a second step S2 of the method, predetermined rules and a text pattern, corresponding to the identified type of the element, are read from a database. The text pattern, which is read, has previously been described. The predetermined rules are user-defined. The predetermined rules comprise for example which properties to present, system of measurement, etc. Each element type can have default settings for some rules, such as which properties to present, then the user can edit, add or remove those default settings.

Preferably, it is possible to create and assign different rules and text patterns for different users. Thus each user or group of users, i.e. target group, can determine, independent or semi-dependent of other users, how the properties of the elements are to be presented.

The database is stored on computer media and preferably in a relational database. But, it could as well be any other kind of database, for example a plain text file.

In the next step S3, the properties of the element, for example diameter or material, are combined with the text pattern while satisfying the predetermined rules, for example it checks which properties of the elements that are to be presented. The properties, which are to be presented, are then assigned to the variables of the actual text pattern. The text pattern having variables with values representing the properties of the actual element now constitute a text string.

In a fourth step S4, the text string is connected to the actual element. There are various ways to connect the text string to the installation element. The text string could for example be written next to the element or on top of the element. In another embodiment, the method comprises the substep S6, wherein a line is drawn between the element and the text string representing the properties of the element. In order to facilitate reading of the representation of the installation system, one of the ends of the line could be an arrow.

In a third embodiment, the method according to the invention would comprise the further step, S5, of determining whether to apply the text string to the representation at all, in which embodiment the predetermined rules also contain information whether a text string is to be presented. Preferably this step is performed before step S2 in order to increase the efficiency of the method. Thereby it becomes possible to eliminate reading the database for those elements having an element type, which rules state that no text string is to be presented. Such elements could for example be elements, for which the user could decide on, e.g. standard elements, which occur in large amounts, such as bolts.

In a fourth embodiment the rules of the element type additionally comprises user defined location constraints and instructions for positioning said text string. These could for example be margins to elements of the representation of the installation system, distance to other text elements, or distance between the text string and the related element. In this embodiment the method comprises the substeps of searching, S7, the representation of an installation system in order to find a location to put the text string satisfying said predetermined rules; and applying, S8, the text string to the representation of the installation system on that location. At least the coordinates of the installation elements together with the coordinates of the text string are possible inputs to the search, i.e. interpretation, of the representation in order to find a location. Preferably the search for a suitable location for the text string is a location, where the text is not placed in front of an installation element.

Preferably, the placement of the text string on the representation is performed in the following way. First an area is defined, comprising the text string and preferably an allowance surrounding the text string. The defined area is preferably a rectangle with a centre corresponding to the centre of the text string. Thereafter, the defined area is placed on a certain starting distance from the centre of the element to which it is to be connected. If the defined area does not overlap any other feature on the representation the text string is placed at this position. Otherwise, certain or all other possible positions on the same distance are tested. If no one of the tested positions avoids overlapping other features, the distance is increased and the same testing procedure is repeated. The increase of the distance from the centre of the element to which the text string is to be connected is preferably a stepwise increment. Hereby, possible positions on concentric and stepwise increasing circles are tested until a position without overlap is found. The first free position found is preferably chosen.

The invention has been described above in terms of a preferred embodiment. However, the scope of this invention should not be limited by this embodiment, and alternative embodiments of the invention are feasible, as should be appreciated by a person skilled in the art. For example, the original representation of the installation system could be created in a non-computer environment. In that case it would first be drawn by hand and then scanned into a computer and stored onto data media. Then, the step of identifying said element type used in said representation would comprise the substeps of obtaining measurements and geometry of an representation element on said representation; comparing said measurements and said geometry with a database containing measurement and geometry data of installation elements; and determining if said representation element is an installation element and conditioned if said representation element is an installation element, determining the element type of said representation element.

Such embodiments should be considered to be within the scope of the invention, as it is defined by the appended claims.

1. A method for automatically generating and connecting a text string to at least one installation element in a representation of an installation system in a computer readable form, such as a CAD-drawing, said text string indicating the properties of said element in said installation system, comprising, for each installation element, the steps of:
identifying the type of said installation element used in said representation of an installation system;
reading for said element type, from a database, predetermined rules and a text pattern corresponding to the type of said element, said rules determining which properties of said element type to present and said text pattern being a layout scheme for said determined properties;
combining, from said representation of the installation system, the properties of said element, such as dimensions, with said text pattern to produce a text string for said element based on said rules; and
connecting said text string with said element in said representation.

2. A method according to claim 1, comprising the further step of:
assigning different predetermined rules and text patterns for different users, allowing generating and connecting a user specific text string for each element.

3. A method according to claim 1, comprising the further steps of:
defining additional rules for said element type, said additional rules settle whether a text string for said element type is to be presented; and
determining, based on said additional rules of said element type, whether said text string is to be presented.

4. A method according to claim 1, wherein said predetermined rules and said text pattern additionally comprises location constraints and instructions for positioning said text string, and the step of connecting said text string comprises the substeps of:
searching said representation of an installation system in order to find a location to put said text string satisfying the predetermined rules; and
applying said text string to the representation of the installation system on said location.

5. A method according to claim 1, wherein, the step of connecting said text string comprises the substep of:
introducing a line between said text string and said corresponding element indicating the relationship between said text string and said element.

6. A method according to claim 1, wherein the step of identifying said element type used in said representation comprises the substeps of:
obtaining at least measurements and geometry of an representation element on said representation;
comparing at least said measurements and said geometry with a database comprising measurement and geometry data of installation elements; and
determining if said representation element is an installation element and conditioned if said representation element is an installation element,
determining the element type of said representation element.

7. A method according to claim 1, wherein each element type corresponds to a text pattern stored in said database, and said text pattern comprises at least one field having a distinct position in said text pattern, and corresponding to a specific variable such as diameter or material.

8. A method according to claim 7, wherein said text pattern comprises at least two fields, having a relative order with respect to both columns and rows of said text pattern.

9. A method according to claim 2, comprising the further steps of:
defining additional rules for said element type, said additional rules settle whether a text string for said element type is to be presented; and
determining, based on said additional rules of said element type, whether said text string is to be presented.

10. A method according to claim 2, wherein said predetermined rules and said text pattern additionally comprises location constraints and instructions for positioning said text string, and the step of connecting said text string comprises the substeps of:
searching said representation of an installation system in order to find a location to put said text string satisfying the predetermined rules; and
applying said text string to the representation of the installation system on said location.

11. A method according to claim 3, wherein said predetermined rules and said text pattern additionally comprises location constraints and instructions for positioning said text string, and the step of connecting said text string comprises the substeps of:
searching said representation of an installation system in order to find a location to put said text string satisfying the predetermined rules; and
applying said text string to the representation of the installation system on said location.

12. A method according to claim 1, wherein the step of connecting the text string to the representation comprises the additional steps of testing positions on a gradually increasing distance from the centre of the installation element until a position is identified on which the text string does not overlap any other features on the representation, and to place the text string on said identified position.

13. A method according to claim 12, wherein the distance is increased in stepwise increments.

14. A method according to claim 12 or 13, wherein at least two positions are tested on each chosen distance.

15. An apparatus for automatically generating and connecting a text string to at least one installation element in a representation of an installation system in a computer readable form, such as a CAD-drawing, said text string indicating the properties of said element in said installation system, comprising:
means for identifying the type of said installation element used in said representation of an installation system;
means for reading for said element type, from a database, predetermined rules and a text pattern corresponding to the type of said element, said rules determining which properties of said element type to present and said text pattern being a layout scheme for said determined properties;
means for combining, from said representation of the installation system, the properties of said element, such as dimensions, with said text pattern to produce a text string for said element based on said rules; and
means for connecting said text string with said element in said representation.

16. A computer-readable medium, on which is stored a computer program comprising instructions for a general purpose computer for automatically generating and connecting a text string to at least one installation element in a representation of an installation system in a computer readable form, such as a CAD-drawing, said text string indicating the properties of said element in said installation system, comprising:
identifying of the type of said installation element used in said representation of an installation system;
reading for said element type, from a database, predetermined rules and a text pattern corresponding to the type of said element, said rules determining which properties of said element type to present and said text pattern being a layout scheme for said determined properties;
combining the properties of said element, such as dimensions, with said text pattern to produce a text string for said element based on said rules; and
connecting said text string to said element in said representation.
